(19) United States
(12) Patent Application Publication
(10) Pub. No.: US 2014/0090490 A1
(43) Pub. Date: Apr. 3, 2014

(54) TRANSDUCER

(71) Applicant: THOMAS KOPP, Wolfach (DE)

(72) Inventor: THOMAS KOPP, Wolfach (DE)

(73) Assignee: VEGA GRIESHABER KG, Wolfach (DE)

(21) Appl. No.: 13/792,347

(22) Filed: Mar. 11, 2013

Related U.S. Application Data
(60) Provisional application No. 61/704,203, filed on Sep. 21, 2012.

(30) Foreign Application Priority Data
Sep. 14, 2012 (DE) 10 2012 108 611.7

(51) Int. Cl. G01D 11/24

(52) U.S. Cl. CPC G01D 11/24
USPC 73/864.91

(57) ABSTRACT

A transducer with a measuring cell and a housing within which the measuring cell is accommodated, The housing has a measurement opening and at least in a fastening section has an electrically insulating surface, wherein the housing has at least one biocidally active surface at least in an area surrounding the measurement opening.

### CROSS REFERENCE TO RELATED APPLICATIONS

This application relates to, and claims priority from German Pat. App. Ser. No. 10 2012 108 611.7 filed Sep. 14, 2012 and U.S. Pat. App. Ser. No. 61/704,203 filed Sep. 21, 2012, the entire contents of each of which are incorporated herein filly by reference.

### FIGURE SELECTED FOR PUBLICATION

FIG. 1

### BACKGROUND OF THE INVENTION

1. Field of the Invention

The present invention relates to a transducer, more particularly, the present invention provides a transducer where resistance is provided against encrustation by small organisms and microorganisms, so that the transducer is resistant to fouling.

2. Description of the Related Art

Transducers with a measuring cell and a housing within which the measuring cell is accommodated are adequately known from the prior art. Such transducers generally have a plastic housing with a measurement opening and are thus electrically insulated. Electrical insulation is necessary since such transducers, if they were to have a metal surface, could form a galvanic cell in the fastening area together with a fastening element or a container in which they are accommodated during the measurement of a filling medium capable of acting as an electrolyte and thus the less noble material, which in most cases is the container or the fastening element, would be consumed as a sacrificial anode.

Transducers, especially pressure probes with insulating housings, especially housings made of plastic, are known for use in measuring filling levels, for example in seawater. However, the known transducers have the problem that they suffer from the phenomenon known in the maritime area as fouling, i.e., encrustation with small organisms and microorganisms. Various experiments with different materials that interfere with surface adhesion, for example polyvinylidene fluoride (PVDF), polytetrafluoroethylene (PTFE), or a tetrafluoroethylene-perfluoropropylene copolymer (FEP), have shown that even these materials cannot prevent encrustation by small organisms and microorganisms on the transducers.

Accordingly, there is a need for a transducer that is designed to be resistant to fouling.

### ASPECTS AND SUMMARY OF THE INVENTION

In response, a transducer is designed to include a measuring cell and a housing in which the measuring cell is accommodated, wherein the housing has a measuring opening and has an electrically insulating surface at least in one fastening section, and further according to an optional aspect of the invention there is a biocidally active surface at least in an area of the housing surrounding the measuring opening.

A biocidally active surface has both herbicidal and pesticidal effects and thus effectively prevents the attachment and multiplication of small organisms and microorganisms, i.e., especially mussels, snails, algae and mosses. In addition, providing the biocidally active surface in an area surrounding the measurement opening means that fouling of the measuring cell positioned inside this measurement opening can be reduced significantly.

This area also especially includes seals placed on the front side which may contain biocidally active particles.

In one proposed alternative embodiment, the housing of the transducer, at least in the fastening section, has an electrically insulating surface, thus preventing a conductive connection from being made between a fastening arrangement for the transducer or a container in which the transducer is positioned and the transducer itself. This prevents a galvanic cell from being produced in conductive media that may lead to corrosion of the less noble metal. In most instances this is the fastening device or the container in which the transducer is placed, so that especially in the case of corrosion of the fastening device, failure of the transducer would result.

Also classified as electrically insulating are materials that have electrical resistance of a magnitude such as to prevent corrosion due to galvanic effects between a holder or a container and the transducer.

Preferably the housing of the transducer is made completely from the insulating material and, at least in the area surrounding the measurement opening, has a housing coating with a biocidal active ingredient or is entirely made of an insulating material, especially plastic with biocidal properties. Such a coating can be produced, for example, by vapor deposition or sputtering with a biocidally active material, especially a metal or a metal alloy. Other possibilities for applying the coating on the housing are, for example, the application of a paint containing a biocidal active substance and the application of a suitable adhesive layer, followed by galvanic coating thereof with a biocidally active metal.

A plastic with biocidal properties can be produced by incorporating, for example, nano-scale particles of a biocidally active metal.

The housing coating preferably has a thickness of at least 0.5 μm, preferably 100 μm.

Use of an adequate thickness of the housing coating means that the housing coating, for example when used in seawater, will achieve a useful life at least equal to that of the measuring cell.

An additional possibility through which an even higher useful life can be achieved consists of making the housing in the area surrounding the measurement opening from a biocidally active material and the remainder from an insulating material. Biocidally active materials considered for use in this area especially include biocidally active metals and their alloys as well as plastics with incorporated biocides, especially nano-scale metal particles.

To prevent colonization of the transducer or a surface of the transducer pointing toward the outside, it may be reasonable to provide the outer surface of the transducer with a biocidal active ingredient. In, for example, pressure measuring cells, it may be reasonable to coat the surfaces of measurement membranes pointing toward the outside with a biocidal active ingredient. An especially simple variant for coating such a measurement membrane is achieved, for example, by vapor-depositing a biocidally active metal, especially copper, on the membrane.

Especially for pressure measurement, ceramic measuring cells are preferably used, wherein a ceramic membrane can be coated particularly well with biocidally active metals.

Such a measuring cell coating or membrane coating preferably has a layer thickness of at least 0.5 μm. The layer thickness of the membrane coating is to be selected such that depending on the measuring range of the measuring cell, no effect or approximately no effect on the measured values takes place. The layer thickness and the material of the membrane coating are adapted to the measurement range of the measurement cell in such a manner that no or approximately no effect on the measured value takes place.

Suitable plastics that are preferably used as insulating material are those selected from the group of the polymers, preferably the fluoropolymers. These plastics are characterized by high chemical stability and very good electrical insulating properties and dielectric properties and also have good, adhesion-reducing surface properties. Fluoropolymers are especially resistant to a large number of acids and bases and other chemical compounds. Preferred compounds for use are polytetrafluoroethylene (PETE), tetrafluoroethylene-perfluoropropylene copolymers (FEP), tetrafluoroethylene-perfluoroalkoxy copolymers (PFA), ethylene-tetrafluoroethylene copolymers (ETFE), polyvinylidene fluoride (PVDF) or perfluoroethylene-propylene.

Preferred biocidally active substances to be considered for use are copper, silver, zinc, alloys containing these metals, or plastics containing these metals in nanoparticle form. Controlled release of the biocide can especially be achieved by embedding nanoparticles in a plastic. Distinct cost advantages can be achieved by using metals with biocidal activity or alloys thereof as coatings or as a sacrificial element applied in the area of the measurement opening. For example, a copper ring arranged at the measurement opening can be provided, which can be easily replaced once its maximum useful life has been reached.

The transducers used usually have a housing that is designed as a cylindrical tube, wherein the measurement opening is provided at one end of the housing and a connecting cable at the other end. Transducers with a corresponding housing are particularly advantageously used in tank riser tubes and in addition to a compact design, also have very good possibilities for sealing, for example by means of O-rings.

When the housing is to be coated, it is advantageous if the biocidal material is provided on the front side of a cylindrical housing extending from the measurement opening and on a jacket section of at least 20-40 mm adjacent to the front side. By providing the biocidal active ingredient both on the front side and on a jacket section of the cylindrical housing surrounding the front side, it is ensured that fouling can take place only on a jacket section that is a great enough distance from the measurement opening so that falsification of measured values by fouling or interference with the measurement process, for example by falling off of the encrustation of fouling matter, can be avoided.

On the whole, the invention is optionally and preferably used in the case of transducers in which the transducer is designed as a pressure measuring cell. The effect of the invention is felt particularly well when the transducer is used in an environment in which fouling with plants, small organisms, and microorganisms is to be anticipated. Preferred application areas are, for example, the measurement of filling levels in sea water or brackish water and in ballast tanks of ocean-going ships.

The above and other aspects, features and advantages of the present invention will become apparent from the following description read in conjunction with the accompanying drawings, in which like reference numerals designate the same elements.

### BRIEF DESCRIPTION OF THE DRAWINGS

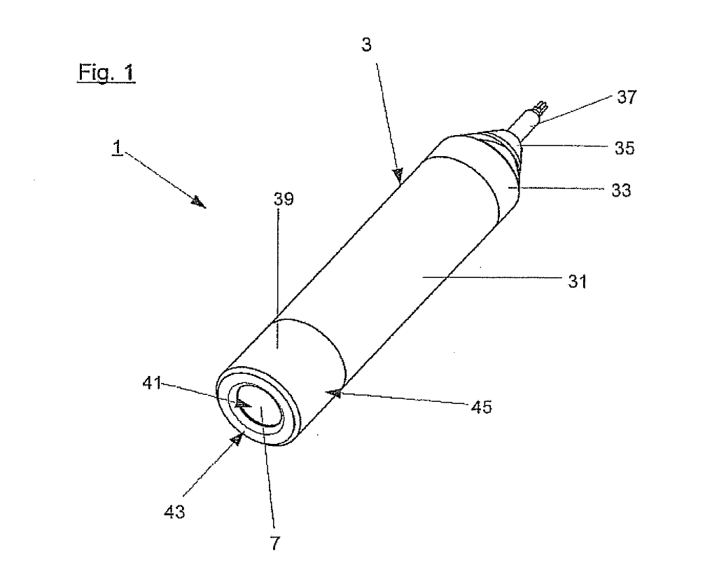

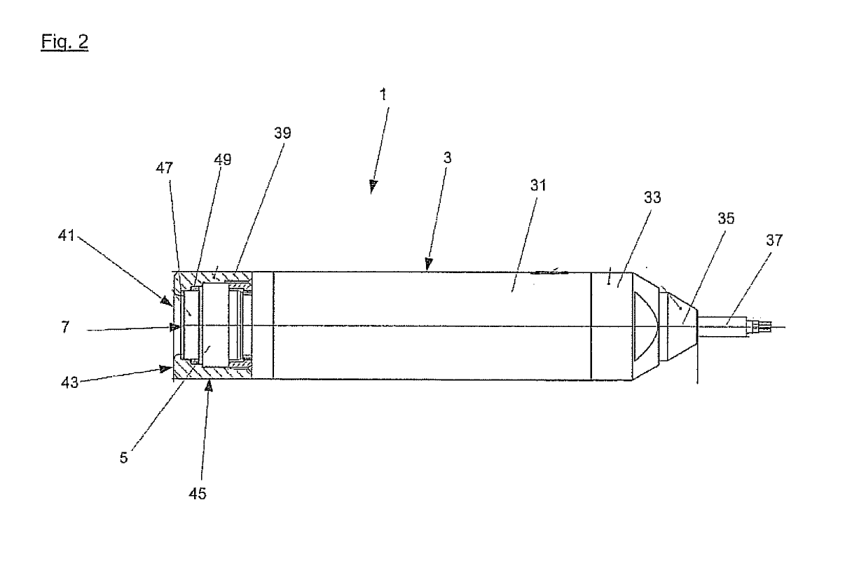

FIG. 1. A perspective view of an example transducer according to the invention.

FIG. 2. A partial longitudinal sectional view of the transducer from FIG. 1.

### DETAILED DESCRIPTION OF THE PREFERRED EMBODIMENTS

Reference will now be made in detail to embodiments of the invention. Wherever possible, same or similar reference numerals are used in the drawings and the description to refer to the same or like parts or steps. The drawings are in simplified form and are not to precise scale. The word ‘couple’ and similar terms do not necessarily denote direct and immediate connections, but also include connections through intermediate elements or devices. For purposes of convenience and clarity only, directional (up/down, etc.) or motional (forward/back, etc.) terms may be used with respect to the drawings. These and similar directional terms should not be construed to limit the scope in any manner. It will also be understood that other embodiments may be utilized without departing from the scope of the present invention, and that the detailed description is not to be taken in a limiting sense, and that elements may be differently positioned, or otherwise noted as in the appended claims without requirements of the written description being required thereto.

Various operations may be described as multiple discrete operations in turn, in a manner that may be helpful in understanding embodiments of the present invention; however, the order of description should not be construed to imply that these operations are order dependent or that all aspects of a particular system described together are required and mandated. Instead, it is the claims the indicate the selected features claimed.

FIG. 1 shows a perspective view of a transducer 1 corresponding to the present invention. A measurement cell 5 (not shown) is arranged in a cylindrically shaped housing 3 with a measurement opening 41 provided on the front side. The housing 3 consists essentially of a cylindrical tube 31, a back side closure 33 and a cable feed-through 35, which are made of a suitable insulated material, preferably a polymer, especially a fluoropolymer. In the present embodiment, the cylinder tube 31, the back side closure 33 and the cable feed-through 35 are made of polyvinylidene fluoride (PVDF). A connecting cable 37 is passed through the cable feed-through 35 from the back side, and at the same time it can serve as a hanger for the transducer 1. In the area of the cylinder tube, fastening of the transducer, for example via a fastening arm and a clamp to a container in which the transducer 1 is arranged, then takes place.

As shown in FIG. 2, the housing 3 is closed on the front by a cylindrically shaped housing cover 39, which has the measurement opening 41 on the front. In the area of the measurement opening 41, the measurement cell 5 is arranged in such a manner that a measurement membrane 7 is arranged directly behind the measurement opening 41. The housing cover 39 is made entirely of copper in the present exemplified embodiment and is screwed together with the cylindrical tube 31. To guarantee tightness, several circumferential sealing mechanisms 47, 49, preferably O-rings, are arranged in between the cylindrical tube 31 and the housing cover 39 as well as the measurement cell 5 and the housing cover 39. By making the housing cover 39 of copper it is ensured that no growth of small organisms and microorganisms takes place. Therefore the so-called fouling is avoided by means of a housing cover 39 made of copper in this area.

To also prevent fouling of the measurement membrane 7 accessible via the measurement opening on the front side, the measurement membrane is also provided with a copper layer.

FIG. 2 shows especially clearly how the measurement cell 5 is arranged in a sealing fashion within the housing cover 39 via the circumferential sealing mechanisms 47, 49. The measuring cell 5 is held in the cover 39 by a clamping device arranged on the back side of the measuring cell.

By making the housing cover 39 of copper, for example, and by coating the measurement membrane 7 with a copper layer, encrustation of the housing cover 39 and the measurement membrane 7 with small organisms and microorganisms can be prevented, which makes it possible to guarantee that the transducer 1 will operate reliably even in the case of extended use in, for example, seawater.

As was previously mentioned, the housing cover 39 can especially be made of copper, silver, zinc, an alloy containing these metals or a plastic containing one of these metals in nanoparticle (small size) form. The decisive factor for the effect of the present invention is that in the area of the housing cover as well as the measurement membrane, a biocidal active ingredient prevents fouling and the transducer 1 is placed in an insulating housing, especially in a fastening area, to prevent formation of a galvanic cell.

### LIST OF REFERENCE NUMERALS

1 Transducer

3 Housing

5 Measuring cell

7 Measurement membrane

31 Cylindrical tube

33 Back side closure

35 Cable feed-through

37 Connecting cable

39 Housing cover

41 Measurement opening

43 Front side

45 Jacket section

47 Sealing mechanism

49 Sealing mechanism

Having described at least one of the preferred embodiments of the present invention with reference to the accompanying drawings, it will be apparent to those skills that the invention is not limited to those precise embodiments, and that various modifications and variations can be made in the presently disclosed system without departing from the scope or spirit of the invention. Thus, it is intended that the present disclosure cover modifications and variations of this disclosure provided they come within the scope of the appended claims and their equivalents.

What is claimed is:

1. A transducer, comprising:
a measuring cell; and
a housing within which the measuring cell is accommodated,
wherein the housing has a measurement opening and an electrically insulating surface at least in a fastening section, and the housing has at least one biocidally active surface at least in an area surrounding the measurement opening.

2. The transducer of claim 1, wherein the housing is entirely made of an insulating material, and at least in an area surrounding the measurement opening, has a housing coating with a biocidally active material.

3. The transducer of claim 2, wherein the housing coating has a thickness of 0.5 μm to 100 μm.

4. The transducer of claim 3, wherein the housing coating has a thickness of 50-100 μm.

5. The transducer of claim 1, wherein the housing in the area surrounding the measurement opening is made of a biocidally active material and otherwise of insulating material.

6. The transducer of claim 1, wherein at least one part of an outer surface of the measuring cell located in the area of the measurement opening has a measuring cell coating with a biocidally active material.

7. The transducer of claim 2, wherein at least one part of an outer surface of the measuring cell located in the area of the measurement opening has a measuring cell coating with a biocidally active material.

8. The transducer of claim 3, wherein at least one part of an outer surface of the measuring cell located in the area of the measurement opening has a measuring cell coating with a biocidally active material.

9. The transducer of claim 4, wherein at least one part of an outer surface of the measuring cell located in the area of the measurement opening has a measuring cell coating with a biocidally active material.

10. The transducer of claim 5, wherein at least one part of an outer surface of the measuring cell located in the area of the measurement opening has a measuring cell coating with a biocidally active material.

11. The transducer of claim 1, wherein the measuring cell is a ceramic pressure measuring cell, the membrane of which is at least partially coated on the outside with a membrane coating made of a biocidally active material.

12. The transducer of claim 5, wherein the measuring cell coating and/or the membrane coating has a layer thickness of at least 0.5 μm.

13. The transducer of claim 5, wherein the measuring cell coating and/or the membrane coating has a layer thickness is 10 μm.

14. The transducer of claim 1, wherein the insulating material is selected from the group of polymers consisting of: fluoropolymers, polytetrafluoroethylene, tetrafluoroethylene-perfluoropropylene copolymers, tetrafluoroethylene-perfluoroalkoxy copolymers, ethylene-tetrafluoroethylene copolymers, polyvinylidene fluoride and perfluoroethylene-propylene.

15. The transducer of claim 1, wherein the biocidally active material is selected from a group consisting of: copper, silver, zinc, an alloy containing copper, silver or zinc metals, and a plastic containing these copper, silver, or zinc metal nanoparticles.

16. The transducer of claim 1, wherein the housing is designed as a cylindrical tube, at one end of which the measurement opening is provided and at the other end, a connecting cable is provided.

17. The transducer of claim 16, wherein the biocidal active substance is provided, beginning from the measurement opening, on a front side of the housing and on an adjacent jacket section of at least 20-40 mm.

18. The transducer of claim 1, wherein the transducer is designed in combination with a pressure measuring cell.
